(19) United States
(12) Patent Application Publication
(10) Pub. No.: US 2026/0227788 A1
(43) Pub. Date: Aug. 6, 2026

(54) ROUTE GENERATION SYSTEM, ROUTE GENERATION METHOD, ROUTE GENERATION DEVICE, AND NON-TRANSITORY COMPUTER READABLE MEDIUM

(71) Applicant: NEC Corporation, Tokyo (JP)

(72) Inventors: Taichi KUMAGAI, Tokyo (JP); Shinya YASUDA, Tokyo (JP)

(73) Assignee: NEC Corporation, Tokyo (JP)

(21) Appl. No.: 19/148,369

(22) PCT Filed: Mar. 29, 2023
(86) PCT No.: PCT/JP2023/012809

§ 371 Date: Jul. 16, 2025

(51) Int. Cl. G05D 1/622; G05D 1/644; G05D 109/10; G05D 109/20

(52) U.S. Cl. CPC G05D 1/622; G05D 1/644; G05D 2109/10; G05D 2109/20

(57) ABSTRACT

The present invention provides a route generation system that generates a route for improving the efficiency of the movement of a moving body. Provided is a route generation system comprising: a memory storing instructions; and a processor configured to execute the instructions to: calculate, for each region constituting a location where a moving body moves, points to be added to points corresponding to the distance the moving body moves to the region, in accordance with the frequency at which an obstacle appears in the region; and generate a route on which the moving body moves, in accordance with the points added to the region. The calculating calculates such that the greater the number of times there is a change as to whether or not the obstacle exists in the region, the more points are added.

### TECHNICAL FIELD

The present disclosure relates to a route generation system, a route generation method, and a route generation device.

### BACKGROUND ART

PTL 1 discloses a method of controlling a moving body that generates a moving route of the moving body in accordance with movement of an obstacle and takes an avoidance action even in a case where there is a dynamic obstacle. PTL 1 describes that an obstacle sensor attached to a ceiling surface sequentially detects a position of an obstacle and sends the position to a control device. The control device described in PTL 1 generates a probability potential field representing a probability that an obstacle may appear based on position information of the obstacle, and adds a gradient toward a target position to the probability potential field. PTL 1 describes that a route toward a target position is searched for based on an inclination of a gradient probability potential field, and a moving body is moved along the route.

### CITATION LIST

### Patent Literature

PTL 1: JP 2003-241836 A

### SUMMARY OF INVENTION

### Technical Problem

PTL 1 generates a route of a moving body by predicting a position of an obstacle when evaluating a dynamic obstacle. However, when the moving route of the moving body is generated according to the detected obstacle every time the obstacle is detected, the efficiency of the movement of the moving body may not be improved. Therefore, an object of the present disclosure is to provide a route generation system that generates a route that improves efficiency of movement of a moving body.

### Solution to Problem

A route generation system of the present disclosure includes:
a calculation means for calculating, for each region constituting a location where a moving body moves, a point to be added to points relevant to a distance the moving body moves to the region, in accordance with a frequency at which an obstacle appears in the region; and
a route generation means for generating a route on which the moving body moves, in accordance with a point added to the region.

A route generation method of the present disclosure includes:
calculating, for each region constituting a location where a moving body moves, a point to be added to points relevant to a distance the moving body moves to the region, in accordance with a frequency at which an obstacle appears in the region; and
generating a route on which the moving body moves, in accordance with a point added to the region.

A route generation device of the present disclosure includes:
a calculation means for calculating, for each region constituting a location where a moving body moves, a point to be added to points relevant to a distance the moving body moves to the region, in accordance with a frequency at which an obstacle appears in the region; and
a route generation means for generating a route on which the moving body moves, in accordance with a point added to the region.

### Advantageous Effects of Invention

The present disclosure provides a route generation system that generates a route for improving the efficiency of the movement of a moving body.

### BRIEF DESCRIPTION OF DRAWINGS

FIG. 1 is a block diagram illustrating a configuration of a route generation system according to an example embodiment.

FIG. 2 is a block diagram illustrating a configuration of a route generation device according to an example embodiment.

FIG. 3 is a flowchart of a route generation method according to an example embodiment.

FIG. 4 is a block diagram illustrating a configuration of a route generation system according to a first example embodiment.

FIG. 5 is a conceptual diagram illustrating a configuration of a route generation system according to the first example embodiment.

FIG. 6 is a diagram illustrating entropy of an obstacle according to the first example embodiment.

FIG. 7 is a diagram illustrating a route generated by the related method according to the first example embodiment and a route generated by the method of the present disclosure.

### EXAMPLE EMBODIMENT

### Example Embodiment

Hereinafter, example embodiments of the present invention will be described with reference to the drawings. However, the invention according to the claims is not limited to the following example embodiment. Not all the configurations described in the example embodiment are essential as a means for solving the problem. To clarify description, omission and simplification are made as appropriate in the following description and drawings. In the drawings, the same elements are denoted by the same reference numerals, and repeated description is omitted as necessary.

### (Description of Route Generation System and Route Generation Device According to Example Embodiment)

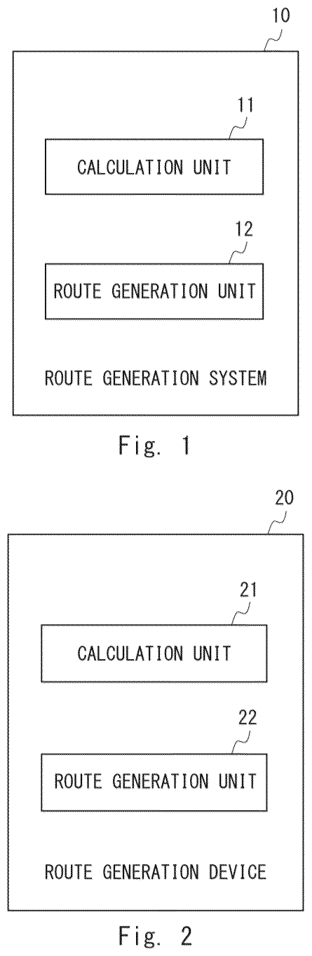

FIG. 1 is a block diagram illustrating a configuration of a route generation system according to an example embodiment. FIG. 2 is a block diagram illustrating a configuration of a route generation device according to the example embodiment. A route generation system and a route generation device according to the example embodiment will be described with reference to FIGS. 1 and 2.

As illustrated in FIG. 1, a route generation system 10 according to the example embodiment includes a calculation unit 11 and a route generation unit 12. The calculation unit 11 and the route generation unit 12 are also replaced with a calculation means and a route generation means. The route generation system 10 is a system that generates a route of a moving body.

The calculation unit 11 calculates, for each region constituting a location where a moving body 410 moves, a point to be added to a point relevant to a distance by which the moving body 410 moves to the region according to a frequency at which an obstacle appears in the region. The “frequency at which an obstacle appears in the region” may be the number of times that an obstacle appears in the region among the number of times that whether an obstacle appears in the region is detected, or may be a ratio of the number of times that whether an obstacle appears in the region to the number of times that an obstacle appears in the region. The “frequency at which an obstacle appears in the region” may be a ratio of a predetermined period and a time during which an obstacle appears in the region.

The region refers to a section obtained by dividing a location where the moving body moves. For example, in a case where one room in which the moving body moves is divided into a lattice shape, the location is one section constituting the divided one room. The location where the moving body moves is not particularly limited, and is, for example, a factory, a restaurant, a warehouse, a construction site, or the like.

As the point relevant to the distance by which the moving body 410 moves to the region, for example, a distance is considered. As the point relevant to the distance by which the moving body 410 moves to the region, other than the distance or in addition to the distance, a gradient, a bend, a time required for the moving body to move, presence or absence of an obstacle, and the like may be considered. The moving body 410 is, for example, a moving body 410 such as a transport robot, an AGV, an AMR, a forklift, a heavy machine, or a drone. The calculation unit 11 calculates a point relevant to a distance by which the moving body 410 moves to a certain location.

The obstacle in the “frequency at which the obstacle appears in the region” is not limited to a specific obstacle. The obstacle may be a person, or may be a mobile robot such as an AGV or an AMR, an animal, a load, a shelf, a wall, or a pillar. In a case where a person passes through the region and then the mobile robot passes through the region, it may be considered that an obstacle appears without distinguishing between the person and the mobile robot.

In particular, the calculation unit 11 not only adds a point in a case where an obstacle appears in a certain region, but also calculates a point to be added according to the frequency at which the obstacle appears in the region. For example, the point to be added may be increased as the ratio between the number of times of detection of whether an obstacle appears in the region and the number of times of presence of an obstacle in the region is closer to 2:1. For example, the point to be added may be increased as the ratio between the predetermined period and the time when the obstacle appears in the region is closer to 2:1. For example, in a case where an obstacle continues to appear in the region or in a case where no obstacle appears in the region during a predetermined period in which whether an obstacle appears in the region is detected, the point to be added may be reduced.

In a case where the point relevant to the distance to move to the region is changed according to the presence or absence of the obstacle, the point may be added as the frequency at which the obstacle appears in the region increases. In a site such as a factory or a warehouse, a pedestrian passage and other passages may be separately provided as safety measures. When viewed from a moving body, for example, a pedestrian passage is a region where an obstacle is frequently present because a person frequently goes back and forth.

The route generation unit 12 generates a route on which the moving body 410 moves according to the point added to the region. The route generation unit 12 may generate a route such that the moving body 410 moves along a route having the lowest total of points in a region passing from the movement start point to the movement end point.

The route generation system includes an information processing device. The information processing device includes a processor (for example, a central processing unit (CPU)) that executes a program for processing information, and a memory that stores the program. The information processing device may be one device or may be configured using a plurality of devices. When configured as one information processing device, as illustrated in FIG. 2, the information processing device is configured as a route generation device 20 including a calculation unit 21 and a route generation unit 22. The information processing device may include a cloud server that processes some or all of the functions in a distributed manner.

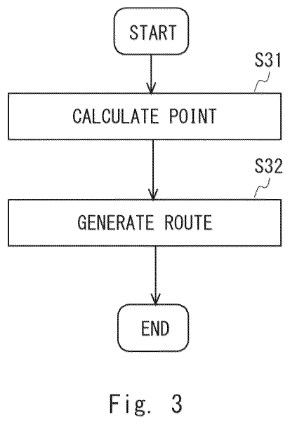

FIG. 3 is a flowchart of a route generation method according to the example embodiment. For example, the route generation method according to the example embodiment is executed by the route generation system in FIG. 1. As illustrated in FIG. 3, first, a point is calculated (step S31). Specifically, for each region constituting a location where the moving body 410 moves, a point to be added to a point relevant to a distance by which the moving body 410 moves to the region is calculated according to a frequency at which an obstacle appears in the region. Next, a route is generated (step S32). Specifically, a route on which the moving body 410 moves is generated according to the point added to the region.

As described above, the route generation system 10 according to the example embodiment generates the route of the moving body according to the frequency at which the obstacle appears. Therefore, for example, the route generation system 10 can generate a route in consideration of the risk of appearance of an obstacle for a region where no obstacle appears at the time of generating the route. For example, in a related technique in which a detour operation is performed every time an obstacle is detected, it is conceivable that a moving distance and a moving time of a moving body become longer than expected as the moving body detours when the obstacle is detected. However, in the case of the route generation system 10 according to the present example embodiment, for example, by generating a route while avoiding a region where appearance of an obstacle is unstable, an unexpected detour operation of the moving body is reduced, and efficiency of movement of the moving body can be improved.

For example, in a case where the ratio between the number of times of detecting whether an obstacle appears in the region and the number of times the obstacle appears in the region or the ratio between the predetermined period and the time when the obstacle appears in the region is close to 2:1, it is considered that the probability that the obstacle appears in the region in terms of time is unstable. By setting a large number of points in a region where the probability that an obstacle appears in terms of time is unstable, it is possible to generate a route while avoiding a region where a change is likely to occur. By generating a route for moving in a region with less change while avoiding a region where a change is likely to occur, it is possible to stably travel the moving body. For example, during the operation of the moving body, a detour route for avoiding an obstacle appearing after route generation is generated, and a possibility that a sudden change is required in the operation of the moving body is reduced.

### (Description of Route Generation System According to First Example Embodiment)

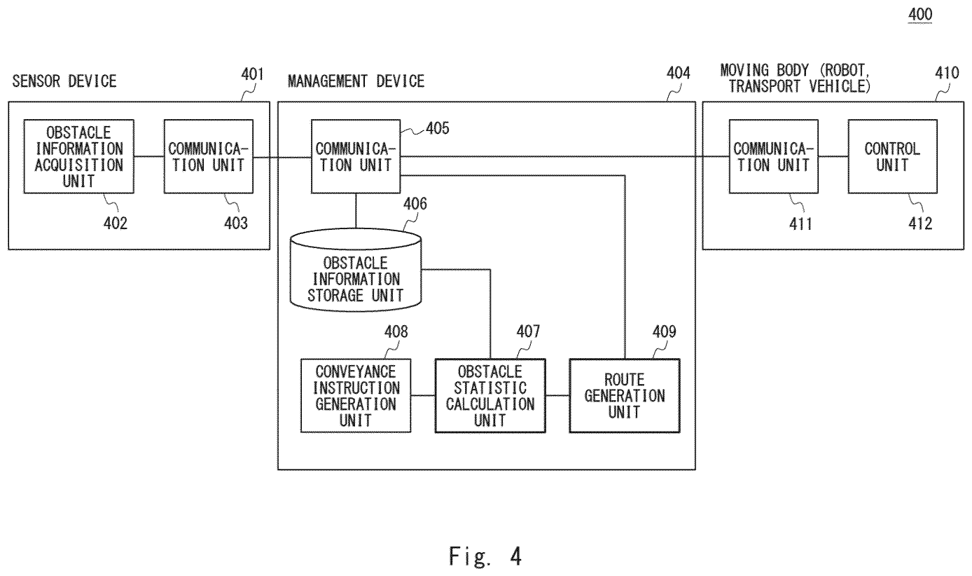

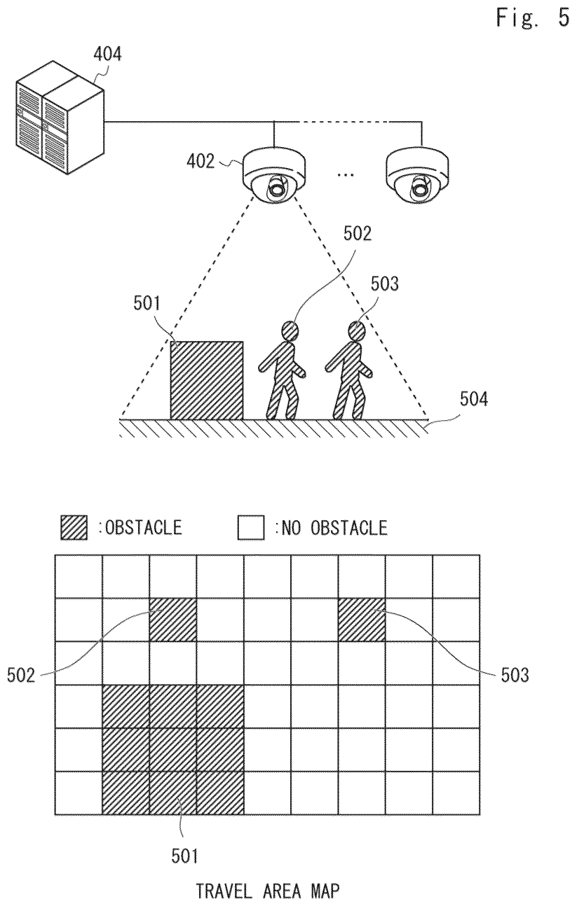

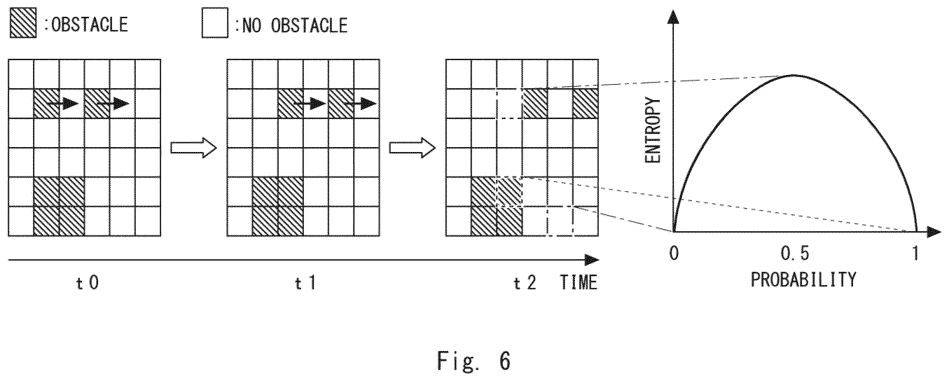

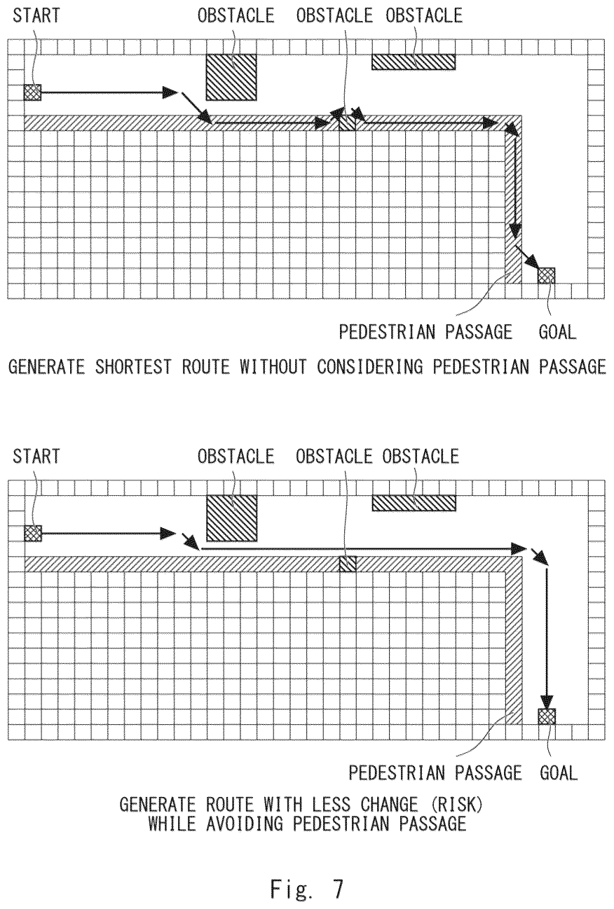

A route generation system according to the first example embodiment will be described with reference to FIGS. 4 to 7. FIG. 4 is a block diagram illustrating a configuration of the route generation system according to the first example embodiment. FIG. 5 is a conceptual diagram illustrating a configuration of the route generation system according to the first example embodiment. FIG. 6 is a diagram illustrating entropy of an obstacle according to the first example embodiment. FIG. 7 is a diagram illustrating a route generated by the related method according to the first example embodiment and a route generated by the method of the present disclosure.

As illustrated in FIG. 4, a route generation system 400 according to the first example embodiment includes a sensor device 401, a management device 404, and a moving body 410. The sensor device 401 includes an obstacle information acquisition unit 402 and a communication unit 403. The management device 404 includes a communication unit 405, an obstacle information storage unit 406, an obstacle statistic calculation unit 407, a conveyance instruction generation unit 408, and a route generation unit 409. The moving body 410 includes a communication unit 411 and a control unit 412.

As illustrated in FIG. 5, the obstacle information acquisition unit 402 is an image capturing device such as a monitoring camera provided on a ceiling, a column, or the like. The monitoring cameras provided on a ceiling, a column, and the like image obstacles such as a person 502, a person 503, and an object 501 moving on a ground 504 from above. The obstacle information acquisition unit may detect the object 501, the person 502, the person 503, and the like by image recognition using artificial intelligence (AI) or the like.

As illustrated in FIG. 4, the communication unit 403 is connected to the communication unit 405 of the management device 404. The connection method may be wired or wireless, but maybe arranged as wired in facility equipment. The communication unit 403 transmits the obstacle information acquired by the obstacle information acquisition unit 402 to the communication unit 405. The obstacle information is information regarding the detected obstacle and includes at least information regarding the position of the obstacle. The obstacle information may be an image or a moving image captured by the image capturing device, or may be information regarding position coordinates of the obstacle. The obstacle information may include object information related to an obstacle.

As illustrated in FIG. 4, the communication unit 405 transmits the obstacle information to the obstacle information storage unit 406. The obstacle information storage unit 406 constitutes a sidebar physical system that constructs a digital twin, and stores object information regarding an obstacle. The object information about the obstacle includes the type of the obstacle, the probability of the type of the obstacle, the predictability of the obstacle, and the like. The type of the obstacle is a classification of the obstacle such as a forklift, a person, and an AGV. The probability of the type of the obstacle represents reliability and probability of the classification of the obstacle, and is, for example, a probability that the detected type of the obstacle is a forklift is 70% and a probability that the type of the obstacle is an AGV is 30%. The predictability of the obstacle is information that the movement of the AGV is easily predicted because the AGV moves regularly in one direction, and the movement of the person is difficult to predict because the person randomly moves around. In a case where the obstacle information is an image or a moving image captured by the image capturing device, the obstacle information storage unit 406 may perform image recognition or the like based on the captured image or moving image to acquire the object information regarding the obstacle. The obstacle information storage unit 406 stores at least the type of the obstacle.

As illustrated in FIG. 4, the obstacle information storage unit 406 transmits at least information regarding the position of the obstacle to the obstacle statistic calculation unit 407. The obstacle information storage unit 406 may transmit the object information regarding the obstacle to the obstacle statistic calculation unit 407 in addition to the information regarding the position of the obstacle. As illustrated in FIG. 5, the obstacle statistic calculation unit 407 defines, for example, a location where an obstacle travels in a grid-like region. Then, the object 501 can be displayed as, for example, 9 squares, the person 502 can be displayed as 1 square, and the person 503 can be displayed as 1 square.

Obstacles such as pillars and facilities do not move, but obstacles such as people and transport moving body move. As illustrated in FIG. 6, it is assumed that there are two objects of four squares that do not move at time to and one square that moves in the arrow direction. At time t1, one moving object moves in the direction of the arrow. At time t2, one moving object moves in the direction of the arrow.

Here, the obstacle statistic calculation unit 407 calculates entropy Hb, which is a statistic of each lattice square, according to the frequency at which the obstacle appears in the region. An entropy function at time t in a certain lattice is expressed by the following Expression (1).

$$[ Math . 1 ]$$

$${H}_{b} ( {p}_{t} ) = - ( {p}_{t} ) \cdot {log}_{2} ( {p}_{t} ) - ( 1 - {p}_{t} ) \cdot {log}_{2} ( 1 - {p}_{t} ) \qquad ( 1 )$$

A probability pt is expressed by Expression (2) using the presence or absence α of an obstacle of a predetermined n steps. Here, α takes 1 in the case of presence and 0 in the case of absence.

$$[ Math . 2 ]$$

$${p}_{t} = \frac{{\sum }_{i = 0}^{n} \vert {α}_{t \to 1} - {α}_{t \to 1 \to i} \vert}{n + 1} ( α ∈ [ 0 , 1 ] ) \qquad ( 2 )$$

In a region represented by a dotted line in FIG. 6, an obstacle appears always, and its entropy is 0. In a region represented by one-dot chain line in FIG. 6, an obstacle does not always appear, and its entropy is 0. In the region represented by the two-dot chain line of the lattice shape in FIG. 6, the presence or absence of an obstacle frequently changes, and the entropy thereof is the highest. The point relevant to the distance by which the moving body 410 moves to the region indicated by the dotted line is high, but there is no point to be added. The number of points relevant to the distance to move to the region indicated by the one-dot chain line in the lattice shape of FIG. 6 is small, and no point is added. In the region represented by the two-dot chain line of the lattice shape in FIG. 6, the number of points relevant to the distance to move to the region is small, but the added point is the highest.

By calculating this entropy, it is possible to calculate a point to be added to a point relevant to the distance by which the moving body moves to the region according to the frequency at which the obstacle appears. For example, the point to be added can be increased as the number of times whether there is an obstacle in the region is changed is increased.

The movement of the obstacle changes for each time zone. For example, in the case of a factory, the movement of the obstacle changes between when parts are delivered in the morning and when parts are assembled in the daytime. Therefore, entropy may be calculated for each time zone. When entropy is calculated, a time interval is arbitrary. After calculating entropy of a certain period in a certain time zone, entropy of a period three times the certain period may be calculated in another time zone.

The frequency at which an obstacle appears in the region is converted into a frequency by a frequency analysis method such as fast Fourier transform (FFT). Then, the more high-frequency components included in the frequency at which the obstacle appears in the converted region, the larger the point to be added may be. When the movement of the obstacle is converted into a frequency, a high-frequency component appears as the frequency of the movement increases.

In a case where the fast Fourier transform is used, a high-pass filter or a low-pass filter is used depending on a situation. When the low-pass filter is used, a slow moving obstacle is emphasized. In a case where the noise is large and the entropy is too high, a low-pass filter is used. In the opposite case, a high-pass filter is used. By using a high-pass filter, a fast moving obstacle is emphasized. After a low-pass filter, a high-pass filter, or a high-frequency emphasis filter is used, discrete Fourier transform (DFT) is performed.

The periodicity in which the obstacle appears is specified for a certain region using the fast Fourier transform, and in a case where the cycle in which the obstacle appears is short, the point may be set large. This is because an obstacle often appears in the region.

In the graph in which the existence probability is on the horizontal axis and the temporal change of the existence is on the vertical axis, even if not entropy, the existence probability of a rectangular shape, a triangular shape, or a trapezoidal shape may be close to 0 or 1 with the horizontal axis as the base.

The obstacle statistic calculation unit 407 adds a point in accordance with information regarding the type of the obstacle present in the region. The obstacle statistic calculation unit 407 can change the point to be added to the region according to the object information in the obstacle information storage unit 406. Points can be added to the region according to the type of an obstacle such as an obstacle that does not move such as a pillar, an obstacle that moves according to a rule such as another moving body, or an obstacle whose movement is difficult to predict such as a person.

The conveyance instruction generation unit 408 gives an instruction of the conveyance destination to the obstacle statistic calculation unit 407. The obstacle statistic calculation unit 407 calculates a point relevant to a distance by which the moving body moves toward the conveyance destination.

The route generation unit 409 generates a route on which the moving body 410 moves according to the point calculated in this manner. For example, the route generation unit 409 generates a route with the least points. In the related route generation system, as illustrated in the upper diagram of FIG. 7, the shortest route that avoids the obstacle on the spot without considering the pedestrian passage is generated. In the route generation system of the present disclosure, as illustrated in the lower diagram of FIG. 7, it is possible to generate a route with less change while avoiding a pedestrian passage with a large amount of human traffic.

The route generation unit 409 may generate a route on which the moving body moves by adding a point to an adjacent region adjacent to a certain region in response to the fact that the point to be added to the certain region is larger than a first threshold. The adjacent regions adjacent to each other constitute a location where the moving body moves. In the region where the frequency of change of the obstacle is high, there is a high possibility that the obstacle appears also in the adjacent region. Therefore, in a case where the point to be added is larger than the preset first threshold, the point may be added to the adjacent region. A point may be added to the adjacent region according to the predictability of the obstacle detected in the certain region. For example, in a case where the number of people is equal to or larger than a predetermined ratio among the obstacles detected in a certain region, the number of points to be added to the adjacent region may be increased as compared with the case where the AGV is equal to or larger than the predetermined ratio among the obstacles detected in the certain region.

The route generation unit 409 generates a route on which the moving body 410 moves again in response to a change in the frequency of the appearance of the obstacle appearing in the region, which has been used to calculate the point to be added, beyond a second threshold. In a case where the frequency of the presence of the obstacle appearing in the region used for the calculation of the point to be added has changed, there is a possibility that the pattern of the presence of the obstacle in the region has changed. In a case where the frequency of the presence of the obstacle changes beyond the predetermined second threshold, the route of the moving body 410 is generated again, so that the route can be reset in real time according to the change in the pattern in which the obstacle appears.

As illustrated in FIG. 4, the communication unit 411 of the moving body 410 wirelessly communicates with the communication unit 405 of the management device 404. In this case, communication can be performed using a wireless LAN such as Wi-Fi (registered trademark) and Bluetooth (registered trademark).

As illustrated in FIG. 4, the control unit 412 of the moving body 410 controls and moves the moving body 410 based on the route generated by the management device 404.

In this way, it is possible to provide a route generation system that generates a route that improves the movement efficiency of the moving body.

Some or all of the processes in the route generation systems 10 and 400 and the route generation device 20 described above can be implemented as a computer program. Such a program can be stored and supplied to the computer using various types of non-transitory computer-readable media. The non-transitory computer-readable media include various types of tangible recording media. Examples of the non-transitory computer-readable media include a magnetic recording medium (e.g., a flexible disk, a magnetic tape, or a hard disk drive), a magneto-optical recording medium (e.g., a magneto-optical disc), a CD-read only memory (ROM), a CD-R, a CD-R/W, and a semiconductor memory (e.g., a mask ROM, a programmable ROM (PROM), an erasable PROM (EPROM), a flash ROM, or a random access memory (RAM)). The program may be supplied to the computer using various types of transitory computer-readable media. Examples of the transitory computer-readable media include electrical signals, optical signals, and electromagnetic waves. The transitory computer readable media can supply the programs to the computer via a wired communication path such as an electric wire and an optical fiber or a wireless communication path.

The present invention is not limited to the above example embodiments, and can be appropriately changed without departing from the gist.

Some or all of the above-described example embodiments may be described as the following Supplementary Notes, but are not limited to the following Supplementary Notes.

### Supplementary Note 1

A route generation system including:
a calculation means for calculating, for each region constituting a location where a moving body moves, a point to be added to points relevant to a distance the moving body moves to the region, in accordance with a frequency at which an obstacle appears in the region; and
a route generation means for generating a route on which the moving body moves, in accordance with a point added to the region.

### Supplementary Note 2

The route generation system according to Supplementary Note 1, in which the calculation means performs calculation in such a way to increase the point to be added as a number of times whether there is an obstacle in the region is changed is increased.

### Supplementary Note 3

The route generation system according to Supplementary Note 1 or 2, in which the calculation means calculates the point to be added for each time zone according to a frequency at which an obstacle appears in the region for each time zone.

### Supplementary Note 4

The route generation system according to any one of Supplementary Notes 1 to 3, in which the calculation means converts a frequency at which the obstacle appears in the region into a frequency, and calculates the point to be added to be larger as a high frequency component included in a frequency at which the obstacle appears in the converted region is larger.

### Supplementary Note 5

The route generation system according to any one of Supplementary Notes 1 to 4, in which the calculation means adds a point based on information regarding a type of the obstacle to the point to be added according to information regarding a type of the obstacle appearing in the region.

### Supplementary Note 6

The route generation system according to any one of Supplementary Notes 1 to 5, in which
the route generation means adds a point to a region adjacent to the region in response to the point to be added in the region being larger than a first threshold to generate a route on which the moving body moves, and
the adjacent region constitutes the location where the moving body moves.

### Supplementary Note 7

The route generation system according to any one of Supplementary Notes 1 to 6, in which the route generation means generates a route on which the moving body moves again in response to a change in a frequency of appearance of an obstacle appearing in the region, the obstacle being used for calculation of the point to be added, beyond a second threshold.

### Supplementary Note 8

The route generation system according to any one of Supplementary Notes 1 to 7, in which the obstacle in the region is monitored by a monitoring camera.

### Supplementary Note 9

A route generation method including:
calculating, for each region constituting a location where a moving body moves, a point to be added to points relevant to a distance the moving body moves to the region, in accordance with a frequency at which an obstacle appears in the region; and
generating a route on which the moving body moves, in accordance with a point added to the region.

### Supplementary Note 10

The route generation method according to Supplementary Note 9, in which the calculation means performs calculation in such a way to increase the point to be added as a number of times whether there is an obstacle in the region is changed is increased.

### Supplementary Note 11

The route generation method according to Supplementary Note 9 or 10, in which the calculation means calculates the point to be added for each time zone according to a frequency at which an obstacle appears in the region for each time zone.

### Supplementary Note 12

The route generation method according to any one of Supplementary Notes 9 to 11, in which the calculation means converts a frequency at which the obstacle appears in the region into a frequency, and calculates the point to be added to be larger as a high frequency component included in a frequency at which the obstacle appears in the converted region is larger.

### Supplementary Note 13

The route generation method according to any one of Supplementary Notes 9 to 12, in which the calculation means adds a point based on information regarding a type of the obstacle to the point to be added according to information regarding a type of the obstacle appearing in the region.

### Supplementary Note 14

The route generation method according to any one of Supplementary Notes 9 to 13, further including adding a point to a region adjacent to the region in response to the point to be added in the region being larger than a first threshold to generate a route on which the moving body moves,
in which the adjacent region constitutes the location where the moving body moves.

### Supplementary Note 15

The route generation method according to any one of Supplementary Notes 9 to 14, further including generating a route on which the moving body moves again in response to a change in a frequency of appearance of an obstacle appearing in the region, the obstacle being used for calculation of the point to be added, beyond a second threshold.

### Supplementary Note 16

The route generation method according to any one of Supplementary Notes 9 to 15, in which the obstacle in the region is monitored by a monitoring camera.

### Supplementary Note 17

A route generation device including:
a calculation means for calculating, for each region constituting a location where a moving body moves, a point to be added to points relevant to a distance the moving body moves to the region, in accordance with a frequency at which an obstacle appears in the region; and
a route generation means for generating a route on which the moving body moves, in accordance with a point added to the region.

### Supplementary Note 18

The route generation device according to Supplementary Note 17, in which the calculation means performs calculation in such a way to increase the point to be added as a number of times whether there is an obstacle in the region is changed is increased.

### Supplementary Note 19

The route generation device according to Supplementary Note 17 or 18, in which the calculation means calculates the point to be added for each time zone according to a frequency at which an obstacle appears in the region for each time zone.

### Supplementary Note 20

The route generation device according to any one of Supplementary Notes 17 to 19, in which the calculation means converts a frequency at which the obstacle appears in the region into a frequency, and calculates the point to be added to be larger as a high frequency component included in a frequency at which the obstacle appears in the converted region is larger.

### Supplementary Note 21

The route generation device according to any one of Supplementary Notes 17 to 20, in which the calculation means adds a point based on information regarding a type of the obstacle to the point to be added according to information regarding a type of the obstacle appearing in the region.

### Supplementary Note 22

The route generation device according to any one of Supplementary Notes 17 to 21, in which
the route generation means adds a point to a region adjacent to the region in response to the point to be added in the region being larger than a first threshold to generate a route on which the moving body moves, and
the adjacent region constitutes the location where the moving body moves.

### Supplementary Note 23

The route generation device according to any one of Supplementary Notes 17 to 22, in which the route generation means generates a route on which the moving body moves again in response to a change in a frequency of appearance of an obstacle appearing in the region, the obstacle being used for calculation of the point to be added, beyond a second threshold.

### Supplementary Note 24

The route generation device according to any one of Supplementary Notes 17 to 23, in which the obstacle in the region is monitored by a monitoring camera.

### REFERENCE SIGNS LIST

10 route generation system
11 calculation unit
12 route generation unit
20 route generation device
21 calculation unit
22 route generation unit
400 route generation system
401 sensor device
402 obstacle information acquisition unit
403 communication unit
404 management device
405 communication unit
406 obstacle information storage unit
407 obstacle statistical calculation unit
408 conveyance instruction generation unit
409 route generation unit
410 moving body
411 communication unit
412 control unit
501 object
502 person
503 person
504 ground

What is claimed is:

1. A route generation system comprising:
a memory storing instructions; and
a processor configured to execute instructions to:
calculate, for each region constituting a location where a moving body moves, a point to be added to points relevant to a distance the moving body moves to the region, in accordance with a frequency at which an obstacle appears in the region; and
generate a route on which the moving body moves, in accordance with a point added to the region.

2. The route generation system according to claim 1, wherein the calculating performs calculation in such a way to increase the point to be added as a number of times whether there is an obstacle in the region is changed is increased.

3. The route generation system according to claim 1, wherein the calculating calculates the point to be added for each time zone according to a frequency at which an obstacle appears in the region for each time zone.

4. The route generation system according to claim 1, wherein the calculating converts a frequency at which the obstacle appears in the region into a frequency, and calculates the point to be added to be larger as a high frequency component included in a frequency at which the obstacle appears in the converted region is larger.

5. The route generation system according to claim 1, wherein the calculating adds a point based on information regarding a type of the obstacle to the point to be added according to information regarding a type of the obstacle appearing in the region.

6. The route generation system according to claim 1, wherein
the generating adds a point to a region adjacent to the region in response to the point to be added in the region being larger than a first threshold to generate a route on which the moving body moves, and
the adjacent region constitutes the location where the moving body moves.

7. The route generation system according to claim 1, wherein the generating generates a route on which the moving body moves again in response to a change in a frequency of appearance of an obstacle appearing in the region, the obstacle being used for calculation of the point to be added, beyond a second threshold.

8. A route generation method comprising:
calculating, for each region constituting a location where a moving body moves, a point to be added to points relevant to a distance the moving body moves to the region, in accordance with a frequency at which an obstacle appears in the region; and
generating a route on which the moving body moves, in accordance with a point added to the region.

9. The route generation method according to claim 8, wherein the calculating performs calculation in such a way to increase the point to be added as a number of times whether there is an obstacle in the region is changed is increased.

10. The route generation method according to claim 8, wherein the calculating calculates the point to be added for each time zone according to a frequency at which an obstacle appears in the region for each time zone.

11. The route generation method according to claim 8, wherein the calculating converts a frequency at which the obstacle appears in the region into a frequency, and calculates the point to be added to be larger as a high frequency component included in a frequency at which the obstacle appears in the converted region is larger.

12. The route generation method according to claim 8, wherein the calculating adds a point based on information regarding a type of the obstacle to the point to be added according to information regarding a type of the obstacle appearing in the region.

13. The route generation method according to claim 8, further comprising adding a point to a region adjacent to the region in response to the point to be added in the region being larger than a first threshold to generate a route on which the moving body moves,
wherein the adjacent region constitutes the location where the moving body moves.

14. The route generation method according to claim 8, further comprising generating a route on which the moving body moves again in response to a change in a frequency of appearance of an obstacle appearing in the region, the obstacle being used for calculation of the point to be added, beyond a second threshold.

15. A route generation device comprising:
a memory storing instructions; and
a processor configured to execute the instructions to:
calculate, for each region constituting a location where a moving body moves, a point to be added to points relevant to a distance the moving body moves to the region, in accordance with a frequency at which an obstacle appears in the region; and
generate a route on which the moving body moves, in accordance with a point added to the region.

16. The route generation device according to claim 15, wherein the calculating performs calculation in such a way to increase the point to be added as a number of times whether there is an obstacle in the region is changed is increased.

17. The route generation device according to claim 15, wherein the calculating calculates the point to be added for each time zone according to a frequency at which an obstacle appears in the region for each time zone.

18. The route generation device according to claim 15, wherein the calculating converts a frequency at which the obstacle appears in the region into a frequency, and calculates the point to be added to be larger as a high frequency component included in a frequency at which the obstacle appears in the converted region is larger.

19. The route generation device according to claim 15, wherein the calculating adds a point based on information regarding a type of the obstacle to the point to be added according to information regarding a type of the obstacle appearing in the region.

20. (canceled)

21. A non-transitory computer readable medium storing a program causing a processor to perform the method according to claim 8.
